(19) United States
(12) Patent Application Publication
(10) Pub. No.: US 2012/0188162 A1
(43) Pub. Date: Jul. 26, 2012

(54) COMPUTER MOUSE

(75) Inventors: HAI-QING ZHOU, Shenzhen City (CN); GUO-YI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/198,860

(22) Filed: Aug. 5, 2011

(30) Foreign Application Priority Data
Jan. 21, 2011 (CN) 201110023791.6

(51) Int. Cl. G09G 5/08

(52) U.S. Cl. 345/163

(57) ABSTRACT

A computer mouse includes a body, a control module, a power supply, and a lighting module. The control module and the power supply are mounted in the body. The power supply is connected to the control module and the lighting module. The light module includes a first light emitter, a second light emitter, and a lighting control unit. The first light emitter emits warm colored light. The second light emitter emits very bright light. The lighting control unit can be used to selectively turn on the first light emitter or the second light emitter.

### BACKGROUND

1. Technical Field

The present disclosure relates to a computer mouse.

2. Description of Related Art

Sometimes a person may need to use a computer in a dark environment. In such conditions, it is difficult to see and use a keyboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a mouse.

FIG. 2 is a block diagram of the mouse of FIG. 1.

FIG. 3 is a circuit diagram of the mouse of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

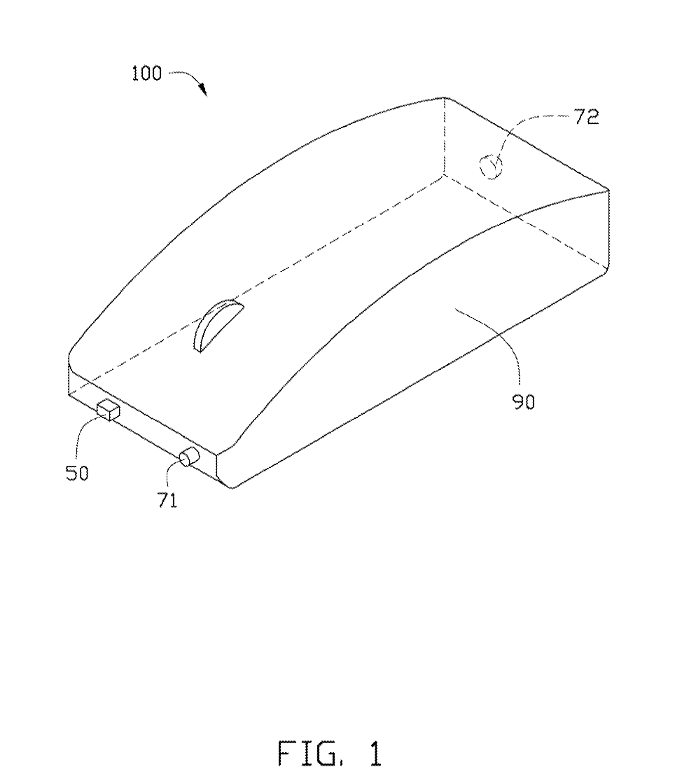

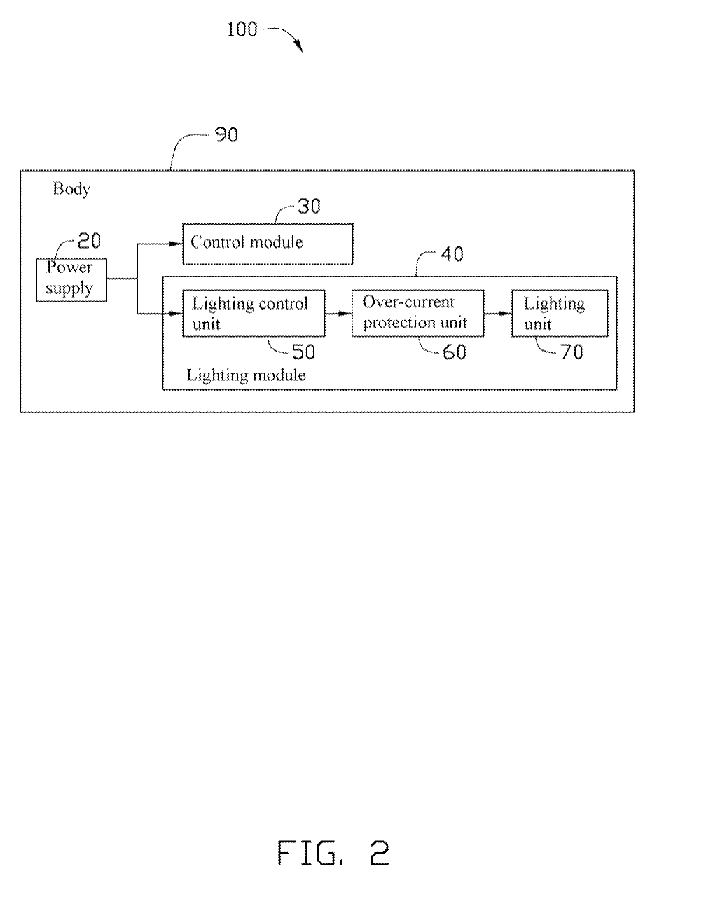

Referring to FIGS. 1 and 2, an exemplary embodiment of a mouse 100 includes a body 90, a power supply 20, a control module 30, and a lighting module 40. The lighting module 40 includes a lighting control unit 50, an over-current protection unit 60, and a lighting unit 70. The lighting unit 70 includes a first light emitter 71 and a second light emitter 72.

The power supply 20 (such as a battery), the control module 30, and the lighting module 40 are mounted in the body 90. The power supply 20 is connected to and powers the control module 30 and the lighting module 40. The control module 30 controls the mouse to work as an ordinary mouse.

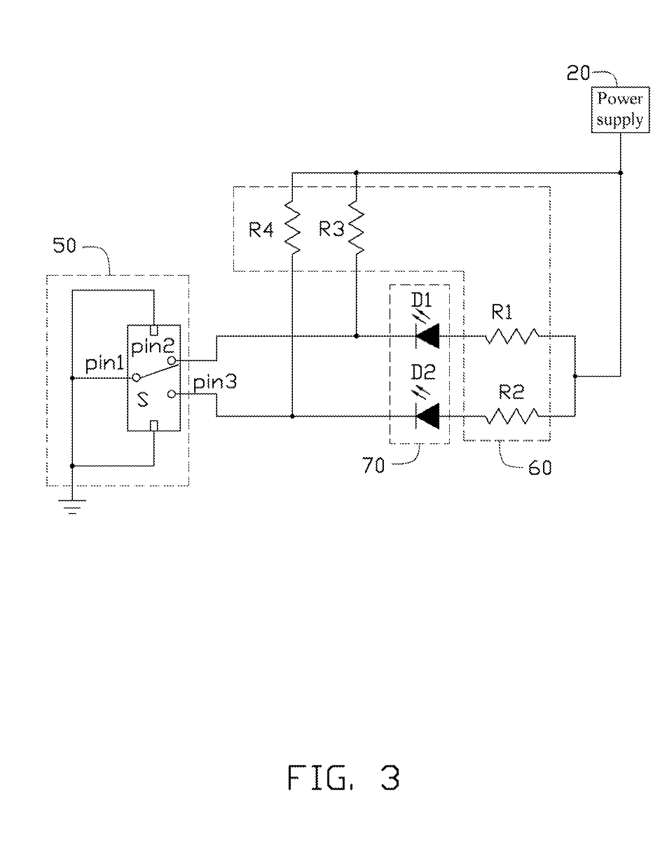

Referring to FIG. 3, the first light emitter 71 is a first light-emitting diode D1. The first diode D1 emits a warm colored light, such as orange. As a result, when the first diode D1 is turned on, a user can more easily see and operate a keyboard of the computer even in a darkened room. The second light emitter 72 is a second light-emitting diode D2. The second diode D2 emits light with high brightness, such as white light. As a result, when the second diode D2 is turned on, the user can see in the area of the computer, and do such things as a read a document or locate a port on the side of the computer even in the dark environment. In the embodiment, the first light emitter 71 is mounted on the front and left side of the body 90. The second light emitter 72 is mounted on the back of the body 90.

The lighting control unit 50 includes a double throw switch S. The double throw switch S includes a pole pin1, and two throws pin2 and pin3. The pole pin1 is selectively connected to the throw pin2 or the throw pin 3 to turn on the first diode D1 or the second diode D2. The lighting control unit 50 is mounted on the front and right side of the body 90.

The over-current protection unit 60 includes four resistors R1, R2, R3, and R4. The resistor R1 is a voltage divider to protect the first diode D1. The resistor R2 is a voltage divider to protect the second diode D2. The resistor R3 is to protect the first diode D1 from over-current. The resistor R4 is to protect the second diode D2 from over-current.

The pole pin1 is grounded. The throw pin2 is connected to a cathode of the first diode D1. An anode of the first diode D1 is connected to the power supply 20 through the resistor R1. The throw pin3 is connected to a cathode of the second diode D2. An anode of the second diode D2 is connected to the power supply 20 through the resistor R2. The throw pin2 is further connected to the power supply 20 through the resistor R3. The throw pin3 is further connected to the power supply 20 through the resistor R4.

When the pole pin1 is connected to the throw pin2, the power supply 20 outputs power to the resistors R3 and R1. As a result, the first diode D1 is turned on. When the pole pin1 is connected to the throw pin3, the power supply 20 outputs power to the resistors R4 and R2. As a result, the second diode D2 is turned on.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A computer mouse comprising:
a body;
a control module mounted in the body;
a power supply mounted in the body, wherein the power supply is connected to the control module for supplying power to the control module; and
a lighting module connected to the power supply, wherein the lighting module comprises:
a lighting unit comprising a first light emitter and a second light emitter, wherein the first light emitter emits a warm colored light, the second light emitter emits light with high brightness; and
a lighting control unit to selectively turn on the first light emitter or the second light emitter.

2. The mouse of claim 1, wherein the lighting module further comprises an over-current protection unit, the over-current protection unit comprises first to fourth resistors, the first resistor is connected between the power supply and the first light emitter, the second resistor is connected between the power supply and the second light emitter, the third and fourth resistors are connected between the power supply and the lighting control unit.

3. The mouse of claim 2, wherein the first light emitter is a first light-emitting diode, the second light emitter is a second light-emitting diode.

4. The mouse of claim 3, wherein the lighting control unit comprises a double throw switch, the double throw switch comprises a pole, a first throw, and a second throw, the pole is grounded, the first throw is connected to a cathode of the first light-emitting diode, an anode of the first light-emitting diode is connected to the power supply through the first resistor, the second throw is connected to a cathode of the second light-emitting diode, an anode of the second light-emitting diode is connected to the power supply through the second resistor, the first throw is further connected to the power supply through the third resistor, the second throw is further connected to the power supply through the fourth resistor.

5. The mouse of claim 1, wherein the lighting control unit is mounted on the front and right side of the body.

6. The mouse of claim 1, wherein the first light emitter is mounted on the front and left side of the body, the second light emitter is mounted on the back of the body.
